(19) United States
(12) Patent Application Publication
(10) Pub. No.: US 2004/0083432 A1
(43) Pub. Date: Apr. 29, 2004

(54) System and method for displaying a threaded document

(75) Inventors: Tateo Kawamura, Yamato-shi (JP); Shinji Yamamoto, Tokyo-to (JP)

Correspondence Address: Samuel A. Kassatly, 6819 Trinidad Drive, San Jose, CA, 95120, US

(73) Assignee: International Business Machines Corporation, Armonk, NY

(21) Appl. No.: 10/671,044

(22) Filed: Sep. 24, 2003

(30) Foreign Application Priority Data
Oct. 23, 2002 (JP) 2002-308821

(51) Int. Cl. G06F 17/00

(52) U.S. Cl. 715/526

(57) ABSTRACT

A threaded document display system generates a virtual document by combining documents within a thread, enabling easy understanding of relations between threaded documents and providing the ability to view multiple documents in a required collection simultaneously. A relation between threaded documents is extracted as a tree structure. A section group with this tree structure is generated in a virtual document from the extracted tree structure before mapping a relation between the documents. Contents of documents corresponding to respective sections are mapped and displayed. Consequently, a plurality of documents may be mapped into a single virtual document. The display shows the content of the virtual combined document rather than a document list. Even if a section is treated as an object embedded in a higher sentence, such as a nested structure, relations between independent documents may be mapped into a single document without expanding a text of the higher document.

### PRIORITY CLAIM

The present application claims the priority of Japanese patent application, Serial No. 2002-308821, titled “Document Display System, Document Display Method, and Program Product,” which was filed on Oct. 23, 2002, and which is incorporated herein by reference.

### FIELD OF THE INVENTION

The present invention relates to a document display system for displaying documents, and more particularly to a document display system for displaying threaded documents.

### BACKGROUND OF THE INVENTION

In an e-mail system for exchanging documents via a network or a bulletin board system, documents resulting from discussions or e-mail exchanges are typically threaded and stored into a document database (DB). In this processing, many applications are used to implement a display method for displaying titles as a document list according to a thread structure and for expanding or omitting the thread.

FIG. 10 illustrates a diagram of a conventional sample display of documents forming a thread. In this illustration, there are a main topic 801 and replies to that main topic 801. Exemplary to the main topic 801 are response 1, 802, and response 2, 803. Replies may be made to posted responses, as indicated by response 1-1, 804, made in reply to response 1, 802. Replies may nest even further, as indicated by replies to response 1-1, 804: response 1-1-1, 805 and response 1-1-2, 806. In a system that exchanges documents via a network as described above, a document list in the thread is displayed by using a tree structure.

Conventional technology embeds a chat window into a related portion in a document for a chat and anchors a communication client to an arbitrary position in an artifact. This arbitrary position in the artifact is a related position in the document such as, for example, in a word-processor document. Conventional technology thus enables a communication associated with the artifact as a communication background by supporting synchronous and asynchronous communications between individuals located in different positions.

The conventional method of displaying titles according to a thread structure as a document list and expanding or omitting the thread is implemented using many applications. This display method does provide a relation between documents that can be easily grasped by a user. Discussions or e-mail exchanges in the conventional method are threaded and stored into a document database. To follow a flow of the discussions or e-mail exchanges, the user must open the documents individually to view their contents. In the conventional art, however, it is impossible to expand a document to view the content on the same view as the document thread.

More specifically, in an e-mail system or a bulletin board system for exchanging documents via a network, an original document and its return document are typically treated as independent documents generated by different users. In this conventional system, a relation between the documents is seen as a relation in a document unit comprising the original document and its return document. On the other hand, contents of individual documents are treated as document specific attributes and consideration has never been made on a relation between contents of multiple documents.

Therefore, as a terminal function of providing a view of documents, a relation between documents such as the original document and the return document has been presented to a user, but the contents of the documents have not been presented as those related to each other. In other words, the document contents themselves have not been expanded on the same view as the document thread as shown in FIG. 10. Consequently, to check discussions or e-mail exchanges, a user is required to open and check the contents of documents one at a time. This process is complicated and grasping the trends within documents or an overview of the collective content of the documents is difficult when viewing each document individually.

Additionally, conventional technology for appropriately associating an object of a chat with the chat embeds a chat window into a related portion in a document for the chat. The chat window is associated with an anchor. An exemplary chat document might be a word processor document. However, it is difficult to expand the contents of the documents on the same view (the same window) as the document thread using this conventional technology.

Another conventional technology displays a document as an outline in a word processor, for example. This technology displays a document by outlining the document structure in the single document. However, this technology has not been used to combine a plurality of threaded documents such as documents exchanged via a network into a single document.

What is therefore needed is a system, a service, a computer program product, and an associated method for providing an easy understanding of a relation between documents. In addition, a method is needed that enables a user to view several documents at a time in a threaded document display. The collection, number, or specification of documents displayed should be user selectable. The need for such a solution has heretofore remained unsatisfied.

### SUMMARY OF THE INVENTION

The present invention satisfies this need, and presents a system, a computer program product, and an associated method (collectively referred to herein as “the system” or “the present system”) for enabling easy understanding of relations between documents of threaded documents and providing the ability to view multiple documents in a required collection at a time. The present system also acquires a virtual document that provides a concurrent view of documents only in a required collection by combining documents in a thread to generate the virtual document. This concurrent view of documents reflects the relation between the documents as a relation between sections in the virtual document.

The present system comprises a document display system. The document display system comprises a document storage unit, a related information storage unit, and a display document generation unit. The document storage unit stores a group of documents exchanged via a network. The related information storage unit stores mutual related information in the group of documents stored in the document storage unit. The display document generation unit reads out related information stored in the related information storage unit to form a section group, The display document generation unit also generates a display document by embedding the document read from the document storage unit into a given section; this section is a component of the section group.

The display document generation unit forms the section group by embedding a document header and a level indicating a depth of hierarchy from the main document. The related information storage unit stores information of a parent document related to a given document.

The present system also comprises a document display system. The document display system comprises a message storage unit for storing messages forming a thread, an index storage unit for storing information on a thread composition in the messages, and a display document generation function of generating a section corresponding to the index by fetching an index of the message from the index storage unit. The display document generation function is used to invoke a given message from the message storage unit and to add that message to a display document by embedding the message into the section.

The present system further comprises an expansion condition storage unit for storing an expansion condition of the message. The display document generation function generates a section by fetching an expansion condition of the message from the expansion condition storage unit. Furthermore, the present system comprises a user interactive processing function of accepting an expansion request to a header from a user. The display document generation function is used to add the given message to the display document on the basis of the expansion request accepted by the user interactive processing function.

A The present system displays documents by:

acquiring related information between documents in a thread from a storage device;

generating a section group based on the related information acquired from the storage device in a virtual document;

reading a document corresponding to a given section which is a component of the section group from the storage device; and

embedding the read document into the section and adding it to a display document.

The section group is generated from a group of documents exchanged via a network. The documents in the thread are a collection of documents whose editing is not scheduled. Acquiring the related information between documents in the thread comprises extracting a relation between documents as a tree structure. Generating the section group in the virtual document comprises generating the section group by using the extracted tree structure.

In addition, the present system displays documents by:

combining documents exchanged via a network with each other and storing headers of the documents into a memory with keeping a relation between the documents;

storing a document corresponding to a given header stored in the memory with keeping the relation between the documents into the memory; and

outputting a content stored in the memory as a display document.

Storing the headers of the documents into the memory comprises generating a section group having a tree structure in a virtual document. Storing the document into the memory comprises storing a content of the document corresponding to the given section with the tree structure.

The present system is a program or programs for causing a server such as a bulletin board server or e-mail client or other computers to perform these functions. More specifically, the present system comprises a program for enabling a computer to provide the functions of storing related information between documents into a storage device. The program of the present system also acquires the related information between the documents in a thread. Further, this program generates a section group based on the acquired related information in a virtual document. In addition, this program reads a document corresponding to a given section that is a component of the section group from the storage device. This program also embeds the read document into the section and adds it to a display document.

The function of acquiring the related information between the documents in the thread comprises extracting a relation of the documents as a tree structure. The function of generating the section group in the virtual document comprises generating a section group that has the extracted tree structure. The function of adding the document to the display document comprises adding the document while keeping the tree structure.

The present system enables a computer to provide the functions of:

combining documents exchanged via a network and storing headers of the documents with keeping a relation between the documents into a memory;

storing a document corresponding to a given header stored in the memory with keeping the relation between the documents into the memory; and

outputting a content stored in the memory as a display document.

More specifically, the function of storing the headers of the documents into the memory comprises generating a section group having a tree structure in a virtual document. The function of storing the document into the memory comprises storing a content of the document corresponding to a given section while keeping the tree structure.

These programs can be provided in a form of programs installed in a computer when the computer is supplied to a customer or in a form of programs computer-readably stored in a storage medium so that the computer executes the programs. The storage medium may be a CD-ROM, for example. A CD-ROM reader or the like reads programs and a flash ROM or the like stores these programs for execution. Furthermore, these programs may be provided via a network using a program transmission device, for example. The program transmission device may be arranged in a server on the network, for example. The program transmission device comprises a memory for storing the programs and a program transmission unit for providing the programs via the network.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a document display system of the present invention may be used;

FIG. 2 is comprised of FIGS. 2A, 2B, and 2C and represents diagrams illustrating examples of corresponding information stored in storage units;

FIG. 3 is a process flowchart illustrating a method of processing of a document display according to the document display system of FIG. 1;

FIG. 4 is a process flowchart illustrating a method of display document generation processing executed by a display document generation function shown in steps 103 and 109 in FIG. 3;

FIG. 5 is comprised of FIGS. 5A, 5B, and 5C and represents explanatory diagrams of assistance in explaining the display document generation processing of the document display system of FIG. 1;

FIG. 6 is a diagram showing an example of a thread display of a virtual document generated by the document display system of FIG. 1;

FIG. 7 is a diagram showing a concrete example of a list at a document title generated by the document display system of FIG. 1;

FIG. 8 is a diagram showing a sample view of contents of the combined documents generated by the document display system of FIG. 1;

FIG. 9 is a functional block of an e-mail system according to the document display system of FIG. 1; and

FIG. 10 is a diagram showing a sample display of documents forming a thread as provided by the document display system of FIG. 1.

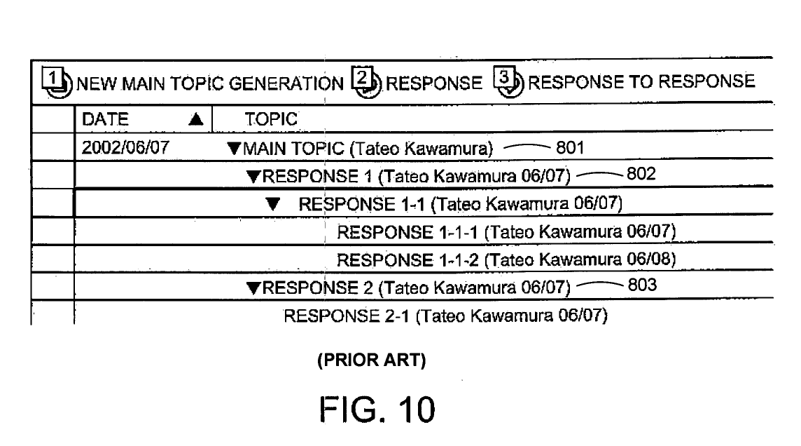

### DETAILED DESCRIPTION OF PREFERRED EMBODIMENTS

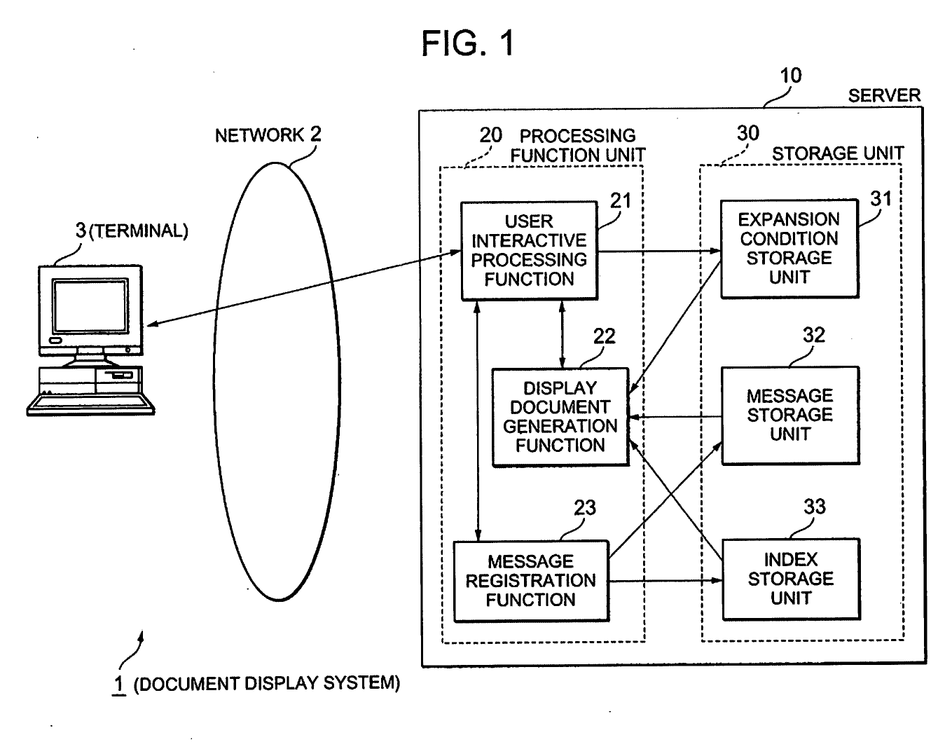

FIG. 1 portrays an exemplary overall environment in which a system and associated method for displaying a threaded document according to the present invention may be used. Document display system 1 includes a software programming code or computer program product that is typically embedded within, or installed on a host server 10. Alternatively, the document display system 1 can be saved on a suitable storage medium such as a diskette, a CD, a hard drive, or like devices. While the system 1 will be described in connection with the WWW, the document display system 1 can be used with a stand-alone database of terms that may have been derived from the WWW and/or other sources.

A terminal (a Web browser, etc.) 3 formed by a computer such as a personal computer (PC) is connected to server 10 that provides the display document to terminal 3. The document display system 1 shown in FIG. 1 is applicable to a bulletin board system, for example. In the bulletin board system, a computer (server computer) managed by a provider, for example, operates server 10, which stores and manages messages transmitted via a network 2 in a database. Additionally a content of the database is supplied to terminal 3 that is a user computer that accesses server 10.

Terminal 3 is one of many computers scattered in a wide area operated by users. The user of terminal 3 uses terminal 3 for registering or browsing messages (documents). Terminal 3 then accesses server 10 via network 2 to send for a WWW page of an application form generated by an organizer of the bulletin board, for example. The user fills in his or her personal information (his or her own e-mail address, etc.) on the page with an item such as a title on the bulletin board for requesting an acquirement of information and transmits it to server 10. In this embodiment, the user can request the message list at terminal 3.

Server 10 is a computer for totally managing the entire bulletin board system and is connected to network 2, for example, the Internet to function as a WWW server and an e-mail server. Server 10 generally comprises a processing function unit 20 and a storage unit 30. The processing function unit 20 is realized in a structure of a CPU and a main storage (memory) in a computer, for example. Server 10 comprises a user interactive processing function 21 that accepts a request from the user operating the terminal 3 via the network 2. Server 10 also comprises a display document generation function 22 that generates a section by fetching an index of a message and referring to a tree structure of the message as a display document generation unit. System 10 further comprises a message registration function 23 registering the acquired message such as a response message. The term “section” references a set of documents or a single “item unit” covering a given header to the next header. The term “section” also references a document format such as a multiple column structure.

The display document generation function 22 combines documents in a thread to generate a virtual document. At that time, a relation between documents is reflected as a relation between sections in the virtual document. The virtual document is stored in the memory in the computer or stored as a file on a hard disk drive (HDD). The generated virtual document is returned to the user interactive processing function 21 as a display document. The user interactive processing function 21 sends out the display document to the terminal 3.

The storage unit 30 is a database managed by the server 10; it is formed by an external storage such as, for example, a hard disk drive (HDD). The storage unit 30 comprises an expansion condition storage unit 31 storing an expansion condition such as presence or absence of a message according to a header. The storage unit 30 also comprises a message storage unit 32 storing contents of actual messages as a document storage unit. The storage unit 30 further comprises an index storage unit 33 storing message index information such as, for example, parent message information to a given title as a related information storage unit.

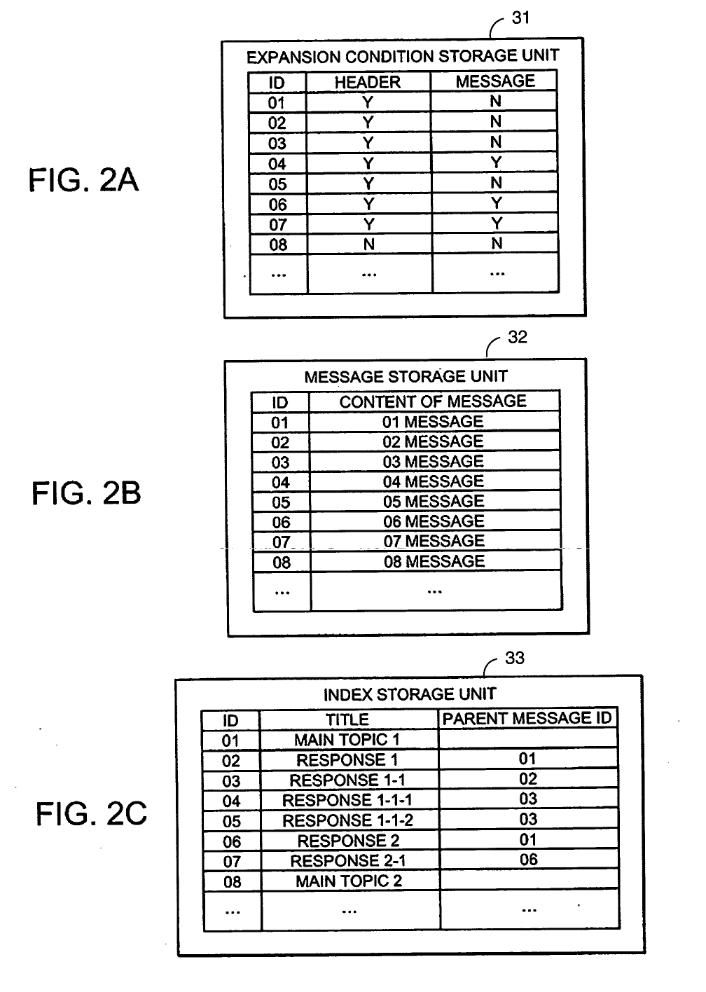

The diagrams of FIG. 2 (FIGS. 2A, 2B, 2C) illustrate examples of information stored in the storage unit 30. FIG. 2A shows a content recorded by the expansion condition storage unit 31. FIG. 2B shows a content recorded by the message storage unit 32. FIG. 2C shows a content recorded by the index storage unit 33. As shown in FIG. 2A, the expansion condition storage unit 31 records the presence or absence (Y/N) of an expanded header and the presence or absence (Y/N) of an expanded message in association with identification information (ID). As shown in FIG. 2B, the message storage unit 32 stores the acquired message contents themselves in association with the identification information (ID). As shown in FIG. 2C, the index storage unit 33 stores relations between titles and parent message IDs in association with the identification information (ID). In connection with the titles, the structure between documents is a tree structure comprising, for example, a main topic, its type, and a response number indicating the response number.

The indices stored in the index storage unit 33 show a thread structure of threaded documents. The term “thread” represents a series of messages written on a specific topic or a small bulletin board for discussing a common theme. A “thread” of messages simply displays a relation between an original message and messages returned to it. It is easier to understand if the thread is grasped in a parent-child relation. A response to a “parent” message generates a “child” message. If more than one response is returned to the parent message, all of these returned messages may be considered to be in a brother relation.

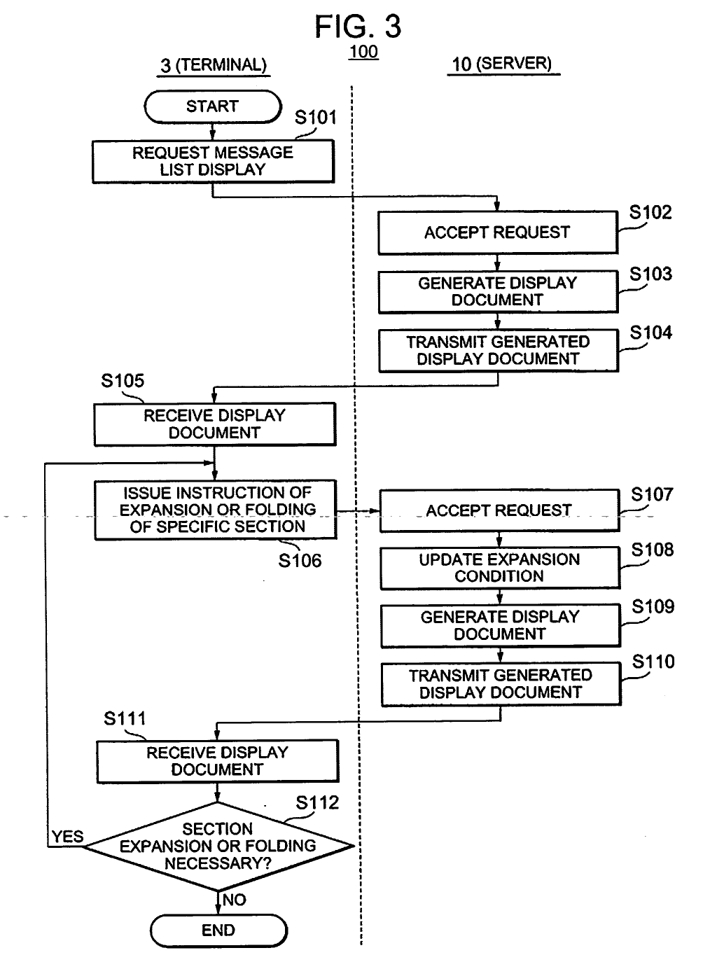

A method 100 of document display processes is illustrated by the process flow chart of FIG. 3. Processes between the terminal 3 and the server 10 are described as a processing flow by method 100. A user requests a message list at the terminal 3 (step S101). Server 10 accepts the request in the user interactive processing function 21 (step S102) and requests the display document generation function 22 to generate a display document. The display document generation function 22 executes the display document generation process by using information stored in the expansion condition storage unit 31, the message storage unit 32, and the index storage unit 33 (step S103). The generated display document is returned from the display document generation function 22 to the user interactive processing function 21 and the user interactive processing function 21 transmits the display document to terminal 3 via network 2 (step S104).

Terminal 3 receives the display document (step S105) and displays it on a screen of a display unit by using the browser of terminal 3, for example. In response to the display document output to the display unit, the user uses terminal 3 to issue an instruction for expanding or folding a specific section (step S106). In server 10, the user interactive processing function 21 accepts the request via network 2 (step S107) and updates the expansion condition stored in the expansion condition storage unit 31 (step S108). The user interactive processing function 21 requests the display document generation function 22 to generate a display document and the display document generation function 22 generates the display document in response to the updated expansion condition (step S109). The generated display document is returned from the display document generation function 22 to the user interactive processing function 21 and the user interactive processing function 21 transmits an output of a display document including a specific section expanded or folded (step S10 This display document is transmitted to terminal 3 via network 2 (step 110).

Terminal 3 receives the display document (step S11) and outputs the received display document on a screen by using, for example, the browser of terminal 3. The document display system 1 determines whether the section expansion or folding is necessary (step S112). If so, the control returns to the step S106. Otherwise, the processing terminates. A series of these processes are executed with an application program in the server 10 as a computer.

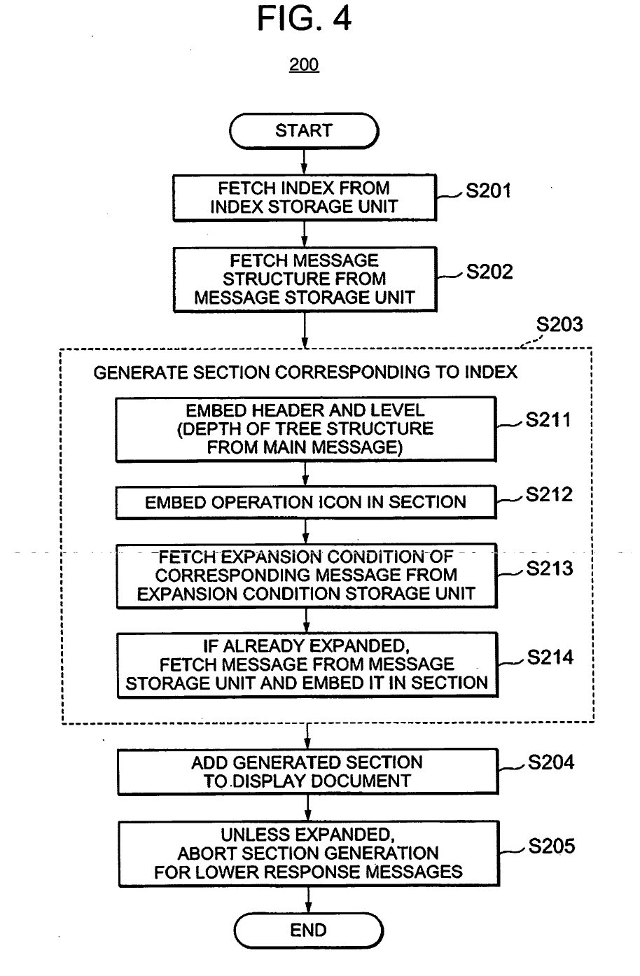

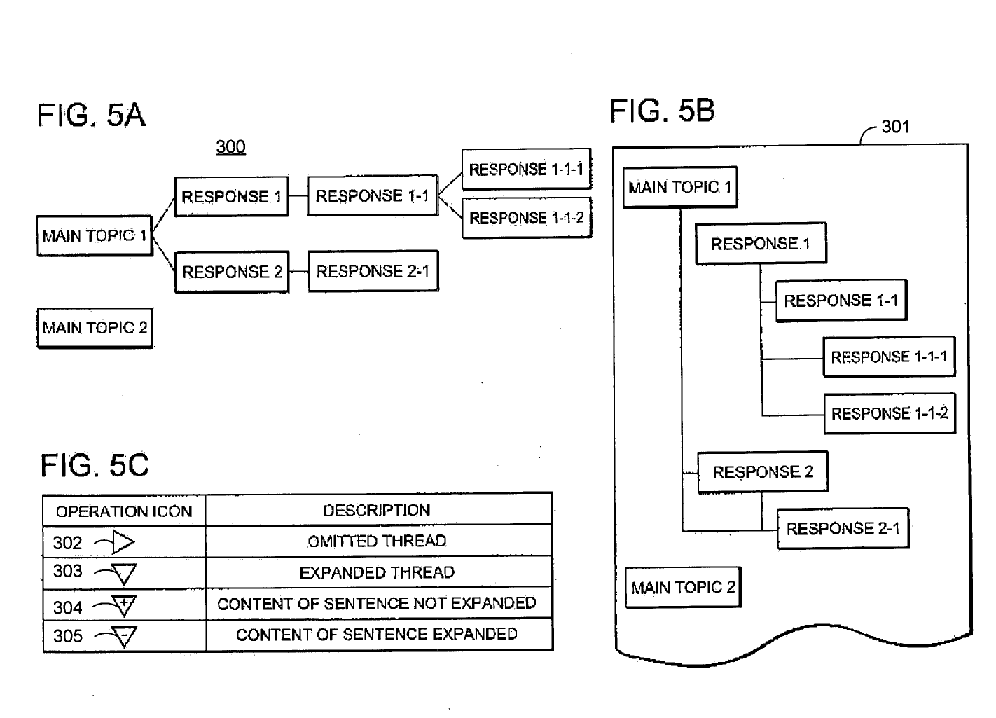

A method 200 for the process of display document generation processing executed by the display document generation function is illustrated by the process flow chart of FIG. 4. Method 200 is executed by the display document generation function 22 in the steps 103 and 109 shown in FIG. 3. Referring to FIG. 5 (FIGS. 5A, 5B, 5C), there are shown explanatory diagrams of assistance in explaining the display document generation processing. In the display document generation function 22, an index is fetched from the index storage unit 33 (step S201) and a message is fetched from the message storage unit 32 (step S202). From the content of the index storage unit 33 illustrated in FIG. 2C, it is understood that the extracted relation between the documents has a tree structure 300 as shown in FIG. 5A.

A section corresponding to the index is generated (step S203). In the section generation, a header and a level (a depth of the tree structure from the main message) are first embedded in the section (step S211). As illustrated in FIG. 5B, for example, a section group 301 corresponding to the extracted tree structure is generated in a virtual document. An operation icon is embedded in the section (step S212). Examples of the operation icon are shown in FIG. 5C. The operation icon 302 shaped as a rightward triangle indicates an omitted thread and the operation icon 303 shaped as a downward triangle indicates an expanded thread. The operation icon 304 with a mark “+” indicates that a content of a sentence is not expanded and the operation icon 305 with a mark “−” indicates that a content of a sentence is expanded. Providing these operation icons 302, 303, 304, 305 enables the user of terminal 3 to issue an instruction for expanding or folding a specific section, for example. There may be wide variations among these user interfaces. For example, it is also possible to add all expanded, all folded, or other functions.

The display document generation function 22 fetches an expansion condition of the corresponding message from the expansion condition storage unit 31 (step S213). The expansion condition storage unit 31 stores information of whether messages have already been expanded in association with document IDs after, for example, an expansion of the instruction of the expansion or folding based on the operation of the above operation icons. The display document generation function 22 fetches a message from the message storage unit 32 and embeds it in the section if the message is expanded as determined from the read expansion condition (step S214).

After the section corresponding to the index is generated in this manner, the display document generation function 22 adds the generated section to the display document (step S204). If the message is not expanded as the expansion condition in the above, section generation processing for the lower response messages is aborted (step S205) and the display document generation processing terminates. The display document may be written in HTML.

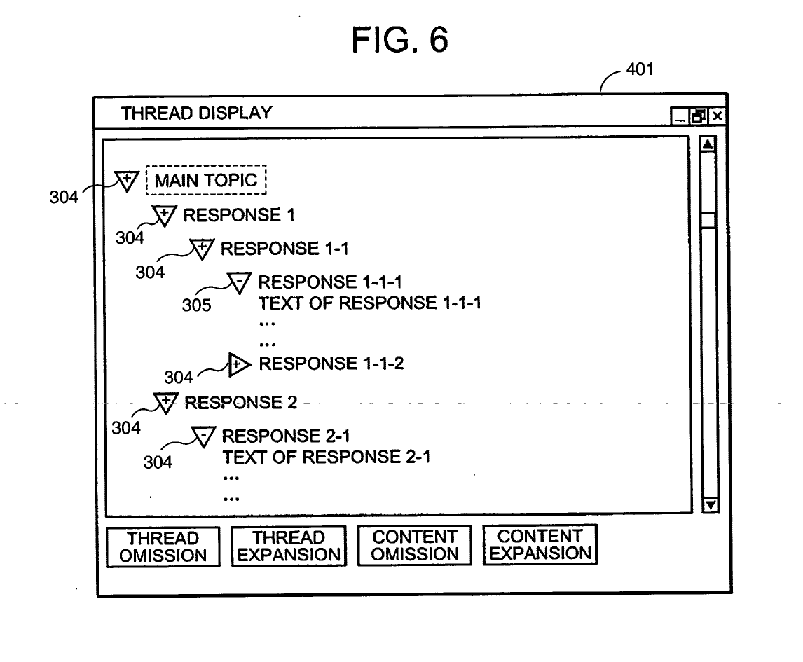

A window 401 displaying an exemplary thread display in the virtual document generated as described above is illustrated in FIG. 6. The thread display is displayed by using a display mechanism supporting the section omission and expansion. The display mechanism enables an easy grasp of a relation between documents and a display where only documents in a required collection may be viewed at a time. A text of an individual document need not always be present statically in the virtual document; it is also possible to have only a pointer (ID) to a text of a document in the original document database (message storage unit 32) from the index information of the virtual document. The virtual document itself need not be a permanent file existing on the HDD, but may be an object temporarily generated on the memory.

While server 10 executes the section expansion or omission processing in the above description, it is also possible to control the section expansion or omission processing in terminal 3. In this case, processing is the same as the above in server 10 up to the step of embedding the section in the virtual document based on the dependency of the message. However, server 10 is assumed to manage neither the expansion nor the omission condition on the display. More specifically, all messages of the thread in the collection of browsing are embedded as a section in the virtual document when the section is embedded. Terminal 3 performs the section expansion or omission by controlling the display or non-display of a section specified by the user. This configuration enables the control of the display or non-display of the section by making full use of JavaScript when using a terminal function including a section display/non-display function or when using a Web browser instead of terminal 3.

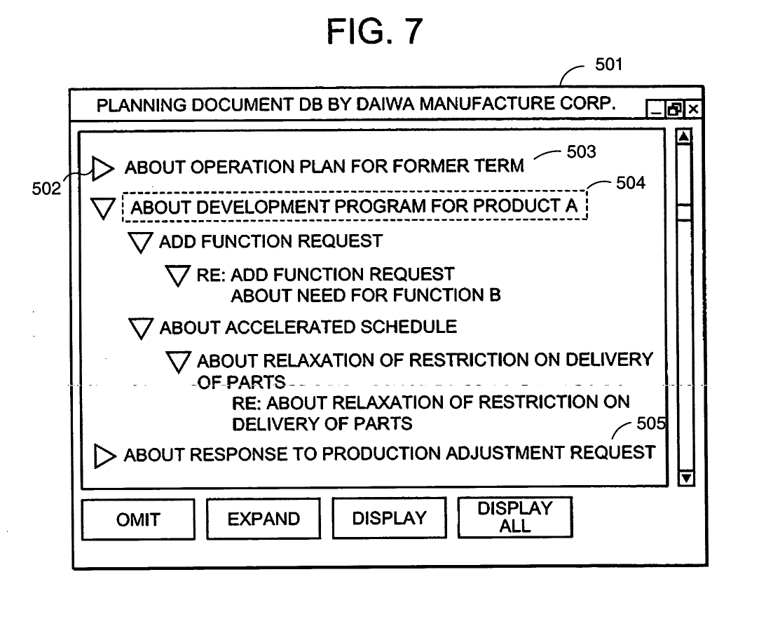

FIG. 7 illustrates a concrete example of window 501 displaying a list of document titles. The documents treated here are those exchanged via network 2; documents in the thread are identified by headers as document titles. A triangle such as triangle 502 is an operation icon and indicates that response documents to each document exist and that they are threaded. In this example, main topic 503 is “About Operation Plan for Former Term”. Consideration is made here for a case where a user wants to view documents in the thread beginning with response 504, “About Development Program for Product A.” In the conventional method, there has been a need for selecting individual documents and displaying the documents one by one.

Although conventionally it is possible to open a plurality of windows and to display a plurality of documents at a time, often the user is required to close the current display documents to display new documents when the number of open documents exceeded a limitation on the number of windows that may be displayed at a time. This limitation leads to a complicated operation and a loss of the user's train of thought due to a shift between the documents. Furthermore, it is hard to grasp the relation between documents displayed on the window. In other words, it is hard to grasp contents by viewing the entire thread in the conventional method.

In contrast, the document display system 1 provides a mechanism by which the document thread and the contents of the documents can be viewed on the same view.

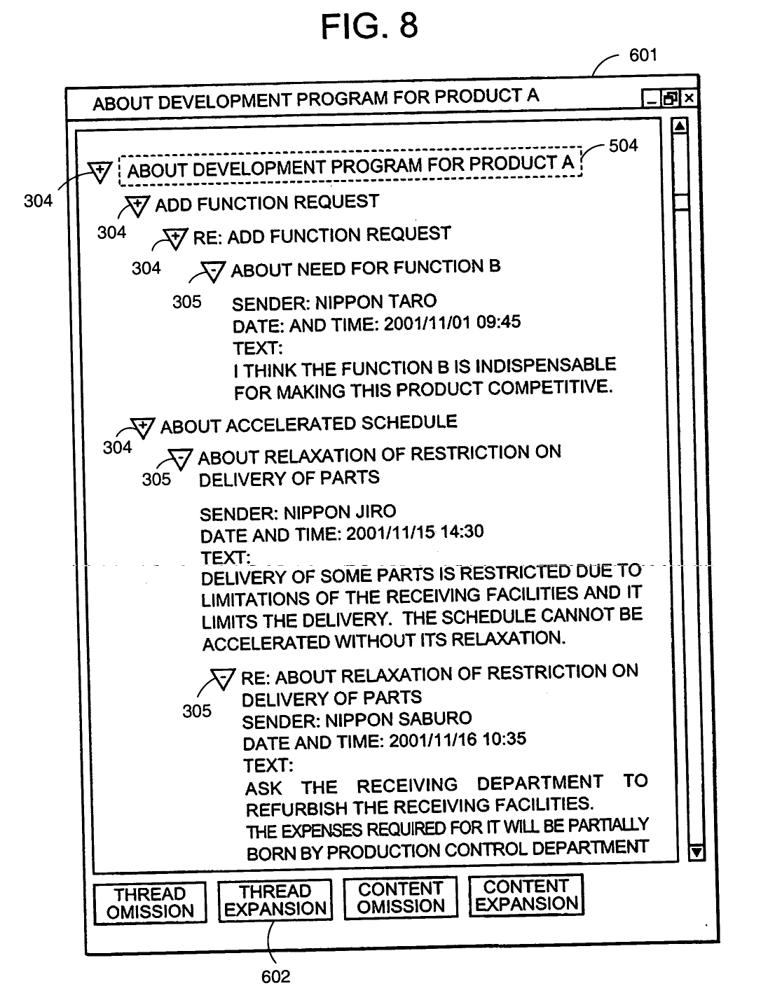

FIG. 8 illustrates a diagram of a window 601 showing a sample view of contents of combined documents. FIG. 8 shows an example displayed when viewing the documents in the thread of FIG. 7. For example, it is possible to select the response 504, “About Development Program for Product A”, as a root document in the window 501 in FIG. 7 and then select the “display all” button for displaying the document. Furthermore, it is possible to display all documents (including from FIG. 7 main topic 503, “About Operation Plan for Former Term”, and response 505, “About Response to Production Adjustment Request”) in a from as shown in FIG. 8 from the main topic 503 to expand the contents on the same view.

In the example shown in FIG. 8, it is assumed that the document content expansion and the document thread expansion may be specified independently. For example, if the “thread expansion” button is depressed, a thread of a response document to the document is expanded, but the document content itself is not expanded. If the “content expansion” button 602 is selected, the document content (sender, date and time, and text) is expanded and displayed. Therefore, the icons indicating the expansion conditions are provided with given meanings as shown in FIG. 5C. This combination is achieved by mapping between a virtual document and an entity document as described above.

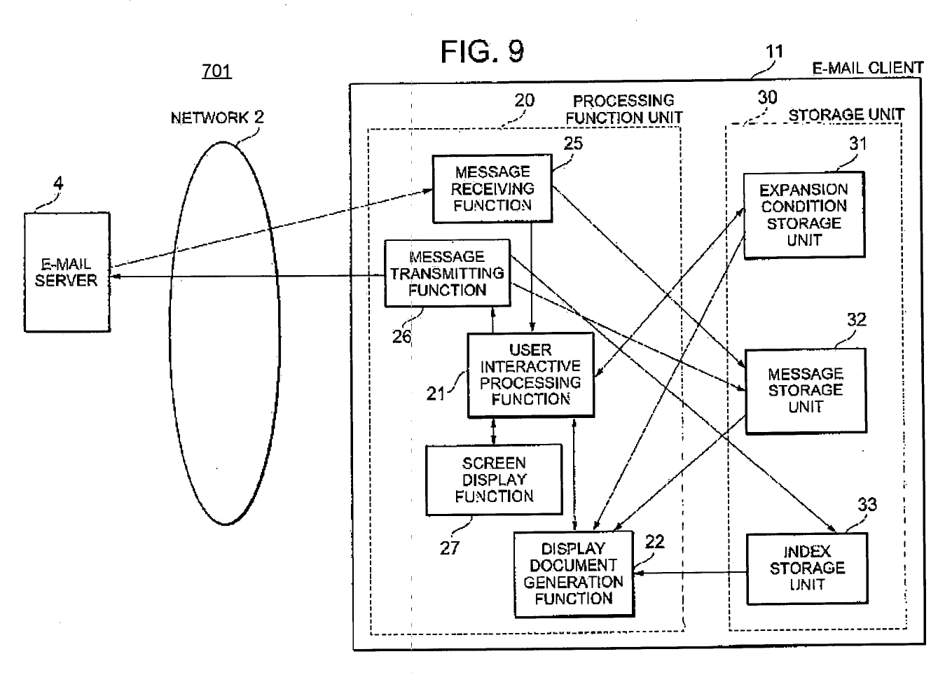

In another embodiment, the document display system 1 is applicable to an e-mail system in a manner similar to the bulletin board system. FIG. 9 illustrates a diagram of a functional block of an e-mail document display system 701 to which this embodiment is applied. The server 10 shown in FIG. 1 corresponds to an e-mail client 11. It transmits or receives a message to or from an e-mail server 4 instead of terminal 3 shown in FIG. 1. The e-mail client 11 shown in FIG. 9 is similar to the server 10 shown in FIG. 1 with additional message transmitting and receiving functions.

A processing function unit 20 in the e-mail client 11 shown in FIG. 9 comprises a message receiving function 25 that receives a message from the e-mail server 4 via a network 2. The processing function unit 20 in the e-mail client 11 also comprises a message transmitting function 26 transmitting a message to the e-mail server 4. The processing function unit in the e-mail client 11 further comprises a screen display function 27 displaying a display document generated by a display document generation function 22 on a screen as an output unit of the display document according to an instruction from a user interactive processing function 21. Components of a storage unit 30, in other words, an expansion condition storage unit 31, a message storage unit 32, and an index storage unit 33 are the same as those in FIG. 1. The above components are provided besides those in FIG. 1 since an e-mail is often downloaded to the e-mail client 11 and managed in the e-mail system. If a user of the Web browser exists as a client, the network 2 exists between the screen display function 27 and the user interactive processing function 21. In this case, still there is no change in the functional block itself.

As described in detail hereinabove, a virtual document is generated by combining documents within a thread. A relation between the documents is reflected as a relation between sections in the virtual document, thereby enabling an easy grasp of the relation between the documents and obtaining a virtual document where only documents in a required collection can be viewed at a time. More specifically, a relation between documents in a thread is extracted as a tree structure, for example, and a section group having the same tree structure is generated in a virtual document on the basis of the extracted tree structure before mapping of the relation between the documents. Thereafter, contents of documents corresponding to respective sections are mapped and displayed. In this manner, the mechanism for mapping a plurality of documents into a single virtual document is provided in this embodiment. The display in this embodiment is not a document list, but the content itself of the virtual combined document can be seen. Furthermore, even if a section is treated as an object embedded in a higher sentence as one in a nested structure, for example, relations between independent documents can be mapped into a single document without expanding a text of the higher document.

It is to be understood that the specific embodiments of the invention that have been described are merely illustrative of certain applications of the principle of the present invention. Numerous modifications may be made to the system, method, and service for displaying a threaded document invention described herein without departing from the spirit and scope of the present invention. Moreover, while the present invention is described for illustration purpose only in relation to the WWW, it should be clear that the invention is applicable as well to, for example, local area networks, wide area networks, or any other network where users share documents and other information.

What is claimed is:

1. A document display system, comprising:
document storage means for storing a group of documents exchanged via a network;
related information storage means for storing related information in the group of documents stored in the document storage means; and
display document generation means for forming a section group and for generating a display document by embedding a document read from the document storage means into a section that is a component of the section group.

2. The system according to claim 1, wherein the display document generation means forms the section group by embedding a document header and a level indicating a depth of hierarchy from a main document.

3. The system according to claim 1, wherein the related information storage means stores information of a parent document related to the document read from the document storage means.

4. A document display system, comprising:
a message storage unit for storing messages forming a thread;
an index storage unit for storing index information on a thread composition in the messages; and
a display document generation unit for generating a section corresponding to the index information by fetching an index of a given message from the index storage unit,
wherein the display document generation unit is used to invoke the given message from the message storage unit and to add the given message to a display document by embedding the given message into the section.

5. The system according to claim 4, further comprising an expansion condition storage unit for storing an expansion condition of the message, wherein the display document generation unit generates a section by fetching an expansion condition of the given message from the expansion condition storage unit.

6. The system according to claim 4, further comprising a user interactive processing unit for accepting an expansion request to a header from a user, wherein the display document generation unit is used to add the given message to the display document on the basis of the expansion request accepted by the user interactive processing unit.

7. A document display method comprising:
acquiring related information between documents in a thread from a storage device;
generating a section group based on the related information acquired from the storage device in a virtual document;
reading a document corresponding to a given section which is a component of the section group from the storage device; and
embedding the read document into the given section and adding the read document to a display document.

8. The method according to claim 7, wherein the section group is generated from a group of documents exchanged via a network.

9. The method according to claim 7, wherein the documents in the thread comprise a collection of documents that are not scheduled for editing.

10. The method according to claim 7, wherein acquiring the related information between documents in the thread comprises extracting a relation between documents as a tree structure; and
wherein generating the section group in the virtual document comprises generating the section group by using the extracted tree structure.

11. A document display method comprising:
combining documents exchanged via a network;
storing headers of the combined documents into a memory;
keeping a relation between the combined documents;
storing a given document corresponding to a given header stored in the memory along with the relation between the combined documents into the memory; and
outputting a content stored in the memory as a display document.

12. The method according to claim 11, wherein storing the headers of the combined documents into the memory comprises generating a section group having a tree structure in a virtual document.

13. The method according to claim 12, wherein storing the given document into the memory comprises storing a content of the given document corresponding to the section group along with the tree structure.

14. A computer program product having instruction codes for displaying a document, comprising:
a first set of instruction codes for acquiring related information between documents in a thread;
a second set of instruction codes for generating a section group based on the acquired related information in a virtual document;
a third set of instruction codes for reading a document corresponding to a given section that is a component of the section group from a storage device; and
a fourth set of instruction codes for embedding the read document into the given section and adding the read document to a display document.

15. The computer program product according to claim 14, further comprising a fifth set of instruction codes for storing the related information between the documents into a storage device.

16. The computer program product according to claim 14, wherein the first set of instruction codes acquires the related information between the documents in the thread by extracting a relation of the documents as a tree structure.

17. The computer program product according to claim 16, wherein the second set of instruction codes generates the section group in the virtual document by generating the section group having the extracted tree structure.

18. The computer program product according to claim 17, wherein the fourth set of instruction codes adds the document to the display document by adding the document along with the tree structure.

19. A computer program product having instruction codes for displaying a document, comprising:
a first set of instruction codes for combining documents exchanged via a network and for storing headers of the documents along with a relation between the documents, into a memory;
a second set of instruction codes for storing a document corresponding to a given header stored in the memory along with the relation between the documents into the memory; and
a third set of instruction codes for outputting a content stored in the memory as a display document.

20. The program product according to claim 19, wherein the first set of instruction codes stores the headers of the documents into the memory by generating a section group having a tree structure in a virtual document; and
wherein the second set of instruction codes stores the document into the memory by storing a content of the document corresponding to a given section along with the tree structure.
